(19) United States
(12) Patent Application Publication
(10) Pub. No.: US 2013/0099121 A1
(43) Pub. Date: Apr. 25, 2013

(54) INFRARED RAY DETECTION ELEMENT AND INFRARED RAY DETECTION DEVICE HAVING THE SAME

(71) Applicants: Takahiro Kawano, Kariya-shi (JP); Kenjiro Fujimoto, Kofu (JP)

(72) Inventors: Takahiro Kawano, Kariya-shi (JP); Kenjiro Fujimoto, Kofu (JP)

(73) Assignee: PIONEER CORPORATION, Kanagawa (JP)

(21) Appl. No.: 13/583,771

(22) PCT Filed: Mar. 10, 2010
(86) PCT No.: PCT/JP2010/001708

§ 371 Date: Oct. 11, 2012

(51) Int. Cl. G01J 5/34

(52) U.S. Cl. CPC G01J 5/34
USPC 250/338.2; 250/338.3

(57) ABSTRACT

An infrared ray detection element has a plurality of pyroelectric layers that are laminated in a same direction as an incident direction of infrared rays, one or more intermediate electrode layers laminated between the plurality of pyroelectric layers; a front side electrode layer that is laminated on a front side of the pyroelectric layer positioned at a top side; and a back side electrode layer that is laminated on a back side of the pyroelectric layer positioned at a bottom side. The two pyroelectric layers adjacent in a front and back direction are performed with a polarization process such that polarization directions thereof are set to reverse directions to each other.

### TECHNICAL FIELD

The present invention relates to an infrared ray detection element in which a plurality of pyroelectric body layers are laminated via intermediate electrode layers and an infrared ray detection device having the same.

### BACKGROUND ART

As this kind of technology, a pyroelectric-type infrared ray detection element is proposed, having a laminated body formed with a plurality of pyroelectric body layers and a plurality of internal electrodes (intermediate electrode layers) laminated alternately, and a pair of external electrodes having an end surface of the laminated body as an infrared ray light reception surface and formed to be connected to the plurality of internal electrodes via the infrared ray light reception surface therebetween (see Patent Document 1).

In the infrared ray detection element, a polarization treatment is performed in a horizontal direction with respect to the infrared ray light reception surface by preliminarily applying voltages to the pair of external electrodes and electric charge movement in the pyroelectric body layer due to temperature change is detected as voltage when infrared rays come on a front side of the infrared ray light reception surface. The infrared ray detection element can easily vary relative detectivity by setting a side surface of the laminated body as the light reception surface of the infrared rays and by adjusting thickness of the laminated body which is cut off in a light reception surface direction.
[Patent Document 1] Japanese Patent laid-open Publication No. 10-082695.

### DISCLOSURE OF THE INVENTION

### Problems that the Invention is to Solve

Since such an infrared ray detection element has a structure in which the end surface of the laminated body made of the plurality of pyroelectric body layers and the plurality of internal electrodes laminated alternately is used as the infrared ray light reception surface, a cutting-off process is needed, by which the element (laminated body) is cut off in a direction orthogonal to a laminated direction after the external electrodes are formed on the laminated body orthogonally to the laminated direction. Therefore, problems arise such that the element tends to be larger and such a bulky element is not appropriate for an infrared ray detection device (such as an imaging device) needed for an element array in which a number of thin-film infrared ray detection elements are arranged in a matrix shape.

It is an advantage of the invention to provide a small-sized infrared ray detection element having high detection sensitivity and an infrared ray detection device having the same.

### Means for Solving the Problems

According to an aspect of the invention, there is provided an infrared ray detection element having a plurality of pyroelectric layers that are laminated in a same direction as an incident direction of infrared rays, one or more intermediate electrode layers laminated between the plurality of pyroelectric layers, a front side electrode layer that is laminated on a front side of the pyroelectric layer positioned at a top side, and a back side electrode layer that is laminated on a back side of the pyroelectric layer positioned at a bottom side, the two pyroelectric layers adjacent in a front and back direction performed with a polarization process such that polarization directions thereof are set to reverse directions to each other, a plurality of pyroelectric layers connected in parallel having an intermediate electrode layer in common, and using added polarization electric charges of a plurality of pyroelectric layers as generated electric charges for detection.

According to the structure above, since a plurality of pyroelectric layers of which front side and back side are sandwiched by electrode layers are provided, the structure thereof corresponds to a structure where a plurality of infrared ray detection elements are laminated. Therefore, since electric charges as detection signals of the infrared rays are generated from respective infrared ray detection elements (pyroelectric layers of which front side and back side are sandwiched by electrode layers), generated electric charges can be increased without making area of the elements (contour area of light reception surface) bigger. Accordingly, it is possible to constitute an infrared ray detection element having high detection sensitivity with high infrared ray detection signals per detection element. Further, since the adjacent pyroelectric layers in a front and back direction (laminated direction) are performed with the polarization treatment to set the pyroelectric layers in reverse directions to each other, making it possible to work the intermediate electrode layer formed between the adjacent two pyroelectric layers as a common electrode. Therefore, it is possible to provide an infrared ray detection elements having high detection sensitivity while keeping a lamination process, material and space in a thickness direction to a minimum. Still further, since all the pyroelectric layers and electrode layers are laminated in an incident direction, it is possible to fabricate an infrared ray detection element by relatively simple processes with a known film-formation method such as a sputtering method or a CVD method. The polarization treatment is performed by applying voltages between the electrodes and this treatment may be performed in a fabrication or after the fabrication for the element.

In this case, it is preferable that the pyroelectric layer be made of a ferroelectric.

According to the structure above, the polarization direction can be easily controlled. In other words, since the ferroelectric can reverse the polarization directions once treated, it is possible to control the polarization direction of a plurality of pyroelectric layers easily and alternately.

According to the other aspect of the invention, there is provided an infrared ray detection device having an infrared ray detection element as described above, and a detection circuit that is connected to the front side electrode layer, the one or more intermediate electrode layers and the back side electrode layer, and detects change of generated electric charges in the plurality of pyroelectric layers.

According to the structure above, it is possible to detect change of electric charges generated in each of the laminated pyroelectric layers and to provide a small-sized infrared ray detection device having high detection sensitivity.

### BRIEF DESCRIPTION OF THE DRAWINGS

FIG. 1 is a schematic cross sectional view of an infrared ray detection element.

FIGS. 2A to 2G are schematic cross sectional views illustrating a fabrication method of the infrared ray detection element.

FIGS. 3A to 3B are views illustrating polarization directions of each pyroelectric layer.

FIG. 4 is a graph illustrating a measured result of residual polarization values of a first pyroelectric body layer.

FIG. 5 is a graph illustrating a measured result of residual polarization values of a second pyroelectric body layer.

FIG. 6 is a graph illustrating a measured result of residual polarization values of the infrared ray detection element.

FIG. 7 is a detection circuit diagram which detects change of electric charges.

FIG. 8 is a schematic cross sectional view illustrating a modification of the infrared ray detection element.

FIGS. 9A and 9B are views illustrating polarization directions of the pyroelectric body layer according to the modification of the infrared ray detection element.

### DESCRIPTION OF EXEMPLARY EMBODIMENTS

An infrared ray detection element according to one embodiment of the invention and an infrared ray detection device having the same will be explained with reference to accompanying drawings. The infrared ray detection element is a pyroelectric-type infrared ray detection element which detects temperature change of a pyroelectric body layer by incident infrared rays as electric signals to detect the infrared rays. Specifically, the infrared ray detection element of the embodiment detects the temperature change of the pyroelectric body layer by the incident infrared rays as change of electric charges. Further, the infrared ray detection device of the embodiment is structured such that a number of infrared ray detection elements are arranged in a matrix shape on mounting and the infrared ray detection element array is connected to a detection circuit.

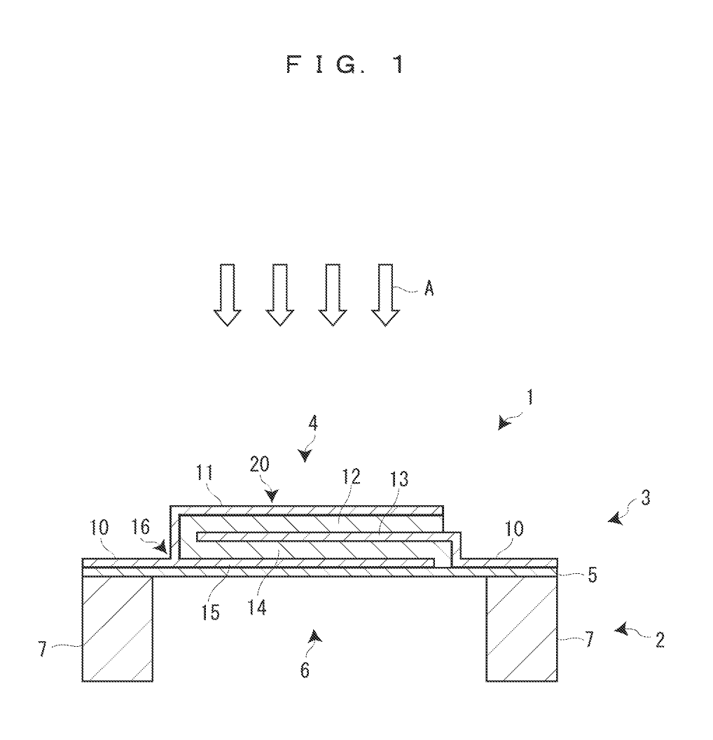

As illustrated in FIG. 1, an infrared ray detection element 1 has a substrate section 2 formed of a silicon substrate and a sensor formation section 3 formed of a plurality of laminated electrode layers and pyroelectric body layers on the substrate section 2, and is formed as, as it is called, a membrane structure. The sensor formation section 3 has a sensor section 4 having infrared ray sensitivity, a support plate section (buffer layer) 5 supporting the sensor section 4 and made of an insulation body, and a pair of wiring sections 10 patterned on the support plate section 5 and extending to right and left from the sensor section 4. Although not illustrated in FIG. 1, the infrared ray detection element 1 is formed in a square seen from above.

The substrate section 2 has a hollow section 6 formed by a deep reactive etching from a back surface side of the silicon substrate as having the support plate section 5 as an etching stop layer, and a frame-shaped substrate body 7 as a remnant portion of the silicon substrate. The hollow section 6 restrains thermal conductivity from the sensor section 4 to the substrate section 2 minimally (thermal insulation) since the silicon substrate is not disposed just under the sensor section 4. It is also possible to form the hollow section 6 by a sacrifice layer.

The support plate section 5 is formed as a thin film to restrain the thermal conduction as possible and supports the sensor section 4 therearound. Shortly, the sensor section 4 is disposed just above the hollow section 6. The pair of wiring sections 10 formed on the support plate section 5 are finally connected to a detection circuit 30 described later. The support plate section 5 corresponds to, as it is called, a beam, and may be formed as a pair of arms (beams) which support the sensor section 4 at point symmetric positions at 180 degrees.

The sensor section 4 is structured by sequentially laminating a front side electrode layer 11 having a light reception surface 20 on which the infrared rays come, a first pyroelectric body layer 12 generating electric charges (electric charges change) after temperature rise by the incident infrared rays, an intermediate electrode layer 13 having a different polarity against that of the front side electrode layer 11, a second pyroelectric body layer 14 generating electric charges by the incident infrared rays as the first pyroelectric body layer 12, and a back side electrode layer 15 having a different polarity against that of the intermediate electrode layer 13. Each layer is laminated in a same direction (front and back direction) as an incident direction A of the infrared rays. Since the sensor section 4 is structured as a thin film, it is conceivable that the temperature rise (sensitivity speed) of the first pyroelectric body layer 12 and the second pyroelectric body layer 14 due to the incident infrared rays occurs almost simultaneously.

One end of the front side electrode layer 11 extends to cover ends of the first pyroelectric body layer 12 and the second pyroelectric body layer 14 and is connected to the back side electrode layer 15 having a same polarity at a connection section 16 reaching the support plate section 5, and one of the wiring sections 10 is connected to the connection section 16. While, the intermediate electrode layer 13 extends to cover the end of the second pyroelectric body layer 14 and the other wiring section 10 is connected thereto on the support plate section 5. Although not illustrated in FIG. 1, the pair of wiring sections 10 extending to the support plate section 5 are formed in a strip shape extending to right and left to be point symmetry at 180 degrees seen from above. Further, the front side electrode layer 11 and the back side electrode layer 15, and the intermediate electrode layer 13 are disposed so as not to conduct electrically with each other.

Thus, the sensor section 4 has a structure in which electrode layers having different polarities are laminated alternately and a plurality of pyroelectric body layers are laminated therebetween. In other words, the sensor section 4 is formed of two pyroelectric body layers of which the front side and the back side are sandwiched by the electrode layers having different polarities. Further, the first pyroelectric body layer 12 and the second pyroelectric body layer 14 have the intermediate electrode layer 13 sandwiched by the two layers in common.

The first pyroelectric body layer 12 and the second pyroelectric body layer 14 are formed of PZT (Pb (Zr, Ti) O₃), SBT (SrBi₂Ta₂O₉), BIT (Bi₄Ti₃O₁₂), LT (LiTaO₃), LN (LiNbO₃), BTO (BaTiO₃), BST (BaSrTiO₃), PTO (PbTiO₃), TGS and the like. Especially, it is preferable that ferroelectric (such as BTO (BaTiO₃), PTO (PbTiO₃), PZT (Pb(Zr,Ti)O₃)) be used in consideration of polarization treatment described later. Each pyroelectric body layer of the embodiment is formed as having approximately 0.2 μm thickness. Further, each pyroelectric body layer may be made of a same material or different materials.

The back side electrode layer 15 and the intermediate electrode layer 13 are formed, for example, with Au, SRO, LSCO, Nb—STO, LNO (LaNiO₃) and the like. In this case, it is preferable that the back side electrode layer 15 and the intermediate electrode layer 13 are formed of a material of which crystal structure is same as that of each pyroelectric body layer in consideration of film formation of the second pyroelectric body layer 14 on the back side electrode layer 15 and growth of the first pyroelectric body layer 12 on the intermediate electrode layer 13. Further, the back side electrode layer 15 and the intermediate electrode layer 13 may be formed of general Pt, Ir, IrOx, Ti or the like.

Since the front side electrode layer 11 has the light reception surface 20, it is preferable that the material thereof have high absorbability of the infrared rays. Further, though the front side electrode layer 11 may be formed of a material same as that of the back side electrode layer 15 and the intermediate electric layer 13, in this case, it is desirable that a separate infrared ray absorbance layer formed of Au-Black or the like be provided on the light reception surface 20 of the front side electrode layer 11. The front side electrode layer 11, the back side electrode layer 15 and the intermediate electrode layer 13 of the embodiment are formed having approximately 0.1 μm thickness.

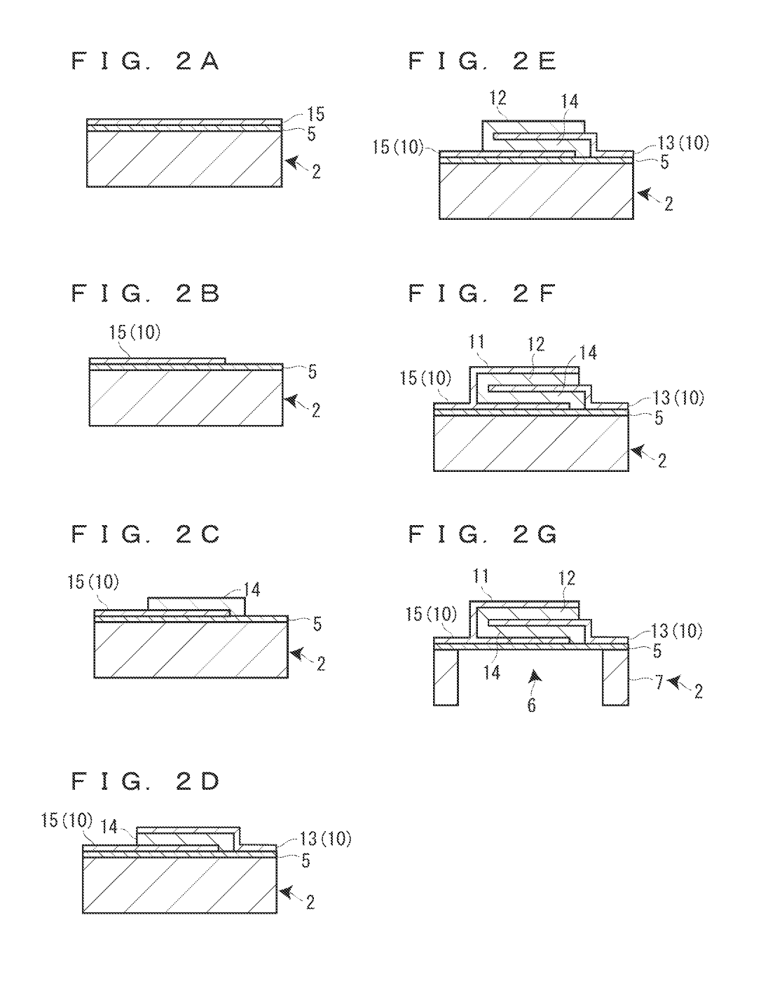

Referring to FIGS. 2A to 2G, a fabrication method of the infrared ray detection element 1 of the embodiment will be explained. First of all, the back side electrode layer 15 is film-formed by a sputtering method or the like on the support plate section 5 (including the buffer layer) on the silicon substrate (FIG. 2A). As illustrated in FIG. 2B, the back side electrode layer 15 and one of the wiring sections 10 are patterned by a photolithography technique and etching or the like. The second pyroelectric body layer 14 is film-formed by the same method as above on the patterned back side electrode layer 15 and a portion except a portion as the sensor section 4 is ablated (FIG. 2C). The intermediate electrode layer 13 and the other wiring section 10 are film-formed and patterned by the same methods on the exposed back side electrode layer 15, the second pyroelectric body layer 14 and the support plate section 5 (FIG. 2D). Likewise, the first pyroelectric body layer 12 and the front side electrode layer 11 are film-formed and patterned (FIGS. 2E and 2F). Thus, after the sensor section 4 is formed, the hollow section 6 is formed by etching the silicon substrate by dry etching (FIG. 2G). The support plate section 5 (including the buffer layer) may include YSZ, CeO₂, Al₂O₃, STO of which crystal structure resembles to that of the pyroelectric body layer as a buffer layer.

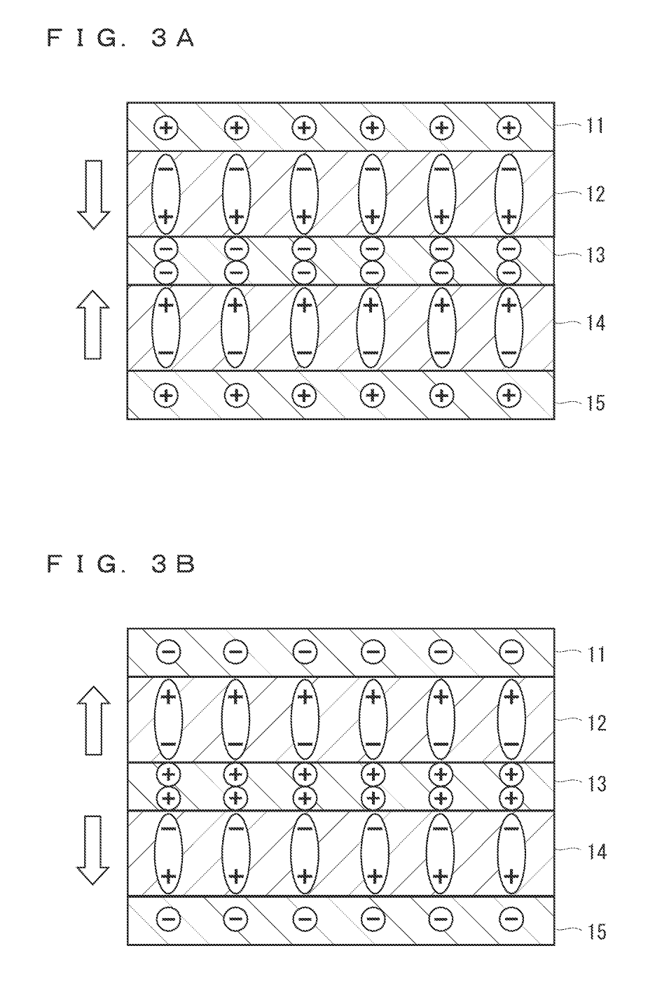

The first pyroelectric body layer 12 and the second pyroelectric body layer 14 in the sensor section 4 of the infrared ray detection element 1 fabricated as described above are processed with the polarization treatment. The polarization treatment is performed by applying voltages for a predetermined time to electrodes which sandwich each pyroelectric body layer. In the embodiment, after the infrared ray detection element 1 is fabricated, the polarization treatment is performed on the first pyroelectric body layer 12 and the second pyroelectric body layer 14 by applying voltages to the pair of wiring sections 10. The polarization treatment allows a polarization direction in each pyroelectric body layer to be aligned. Since the front side electrode layer 11 and the back side electrode layer 15 are conducted at the connection section 16, as illustrated in FIG. 3A, the polarization direction of the first pyroelectric body layer 12 is set from the front side electrode layer 11 to the intermediate electrode layer 13 and the polarization direction of the second pyroelectric body layer 14 is set from the back side electrode layer 15 to the intermediate electrode layer 13 when positive voltages are applied to the front side electrode layer 11 and the back side electrode layer 15 with respect to the intermediate electrode layer. In other words, the polarization direction of each pyroelectric body layer is set to be against each other. Further, the polarization directions may be controlled, as directions illustrated in FIG. 3B, by reversing the voltages applied to the front side electrode layer 11 and the back side electrode layer 15 and the voltage applied to the intermediate electrode layer 13. In short, the polarization treatment is performed such that the polarization directions of the first pyroelectric body layer 12 and the second pyroelectric body layer 14 are set to reverse directions to each other via the intermediate electrode layer 13.

In the preferred embodiment, the polarization treatment is performed after the infrared ray detection element 1 is fabricated described above and the polarization directions of the two pyroelectric body layers are controlled by one polarization treatment. The polarization direction may be controlled by performing the polarization treatment when the infrared ray detection element 1 is being fabricated and by performing the polarization treatment per pyroelectric body layer.

Thus, it is possible to control the polarization directions of the first pyroelectric body layer 12 and the second pyroelectric body layer 14 which are adjacent via the intermediate electric layer 13 in reverse directions to each other by disposing the intermediate electrode layer 13 having a different polarity between the front side electrode layer 11 and the back side electrode layer 15 having a same polarity. Further, since the intermediate electrode layer 13 is used as a common electrode layer for the first pyroelectric body layer 12 and the second pyroelectric layer 14, it is possible to form the sensor section 4 having minimal layers.

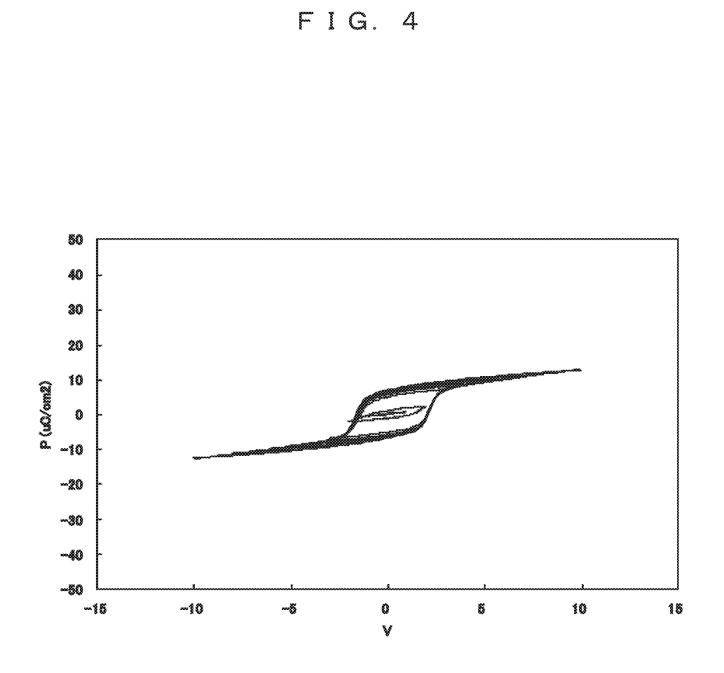

Next, referring to FIG. 4 to FIG. 6, residual polarization values of the infrared ray detection element 1 will be explained. Values of the residual polarization values indicate polarization charges when external electric field is set to zero for a pyroelectric body layer performed with the polarization treatment. Further, the polarization charges relates to generated electric charges as detection signals of the infrared rays of the infrared ray detection element 1.

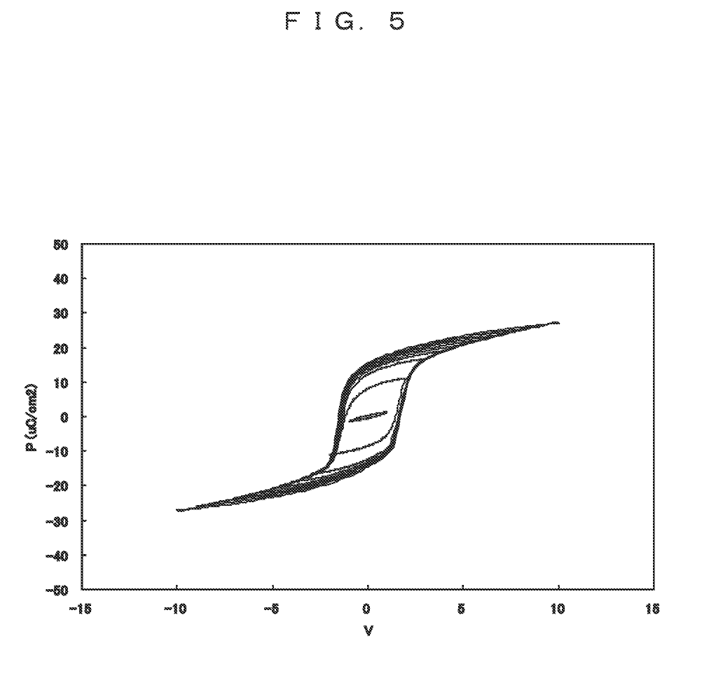

FIG. 4 illustrates a measured result of the residual polarization values of only the first pyroelectric body layer 12 performed with the polarization treatment by which the polarization directions are set as illustrated in FIG. 3A. Also, FIG. 5 illustrates a measured result of the residual polarization values of only the second pyroelectric body layer 14 performed with the polarization treatment in a similar way. These measured results are based on measurement of residual polarization values of a same laminated structure as the infrared ray detection element having a single pyroelectric layer. As illustrated, the residual polarization value Q1 of only the first pyroelectric body layer 12 is Q1˜6.5, and the residual polarization value Q2 of only the second pyroelectric body layer 14 is Q2˜15.

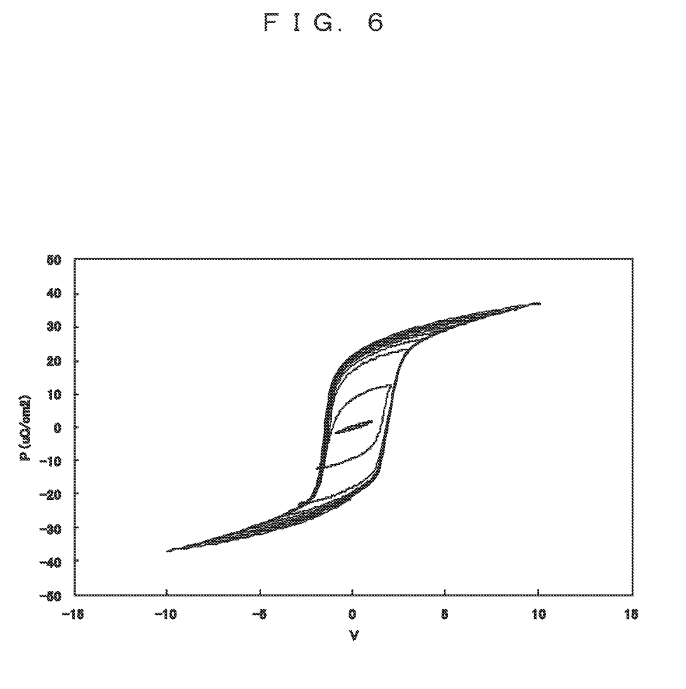

While, FIG. 6 illustrates a measured result of the residual polarization values of the infrared ray detection element 1 of the embodiment which is performed with the polarization treatment in a same manner, that is, of a laminated structure in which the first pyroelectric body layer 12 and the second pyroelectric body layer 14 are laminated in parallel. As illustrated, the residual polarization value Q3 of the infrared ray detection element 1 is Q3˜20.

From the measured results above, Q1+Q2˜Q3, and the polarization electric charges of the infrared ray detection element 1 corresponds to a total value by adding the polarization electric charges of only the first pyroelectric body layer 12 with the polarization electric charges of only the second pyroelectric body layer 14. In other words, regarding the polarization electric charges of the infrared ray detection element 1 in overall, since the polarization directions are controlled to be set to reverse directions mutually as described above, it is indicated that the polarization electric charges of the two layers are generated without cancelling out the mutual polarization electric charges even the first pyroelectric layer 12 and the second pyroelectric layer 14 are laminated.

In order to increase the electric charge, though it is conceivable that two infrared ray detection elements each of which has a single pyroelectric body layer may be arranged in a flat surface, it may be said that the infrared ray detection element 1 can generate more electric charges by one (element) infrared ray light reception area.

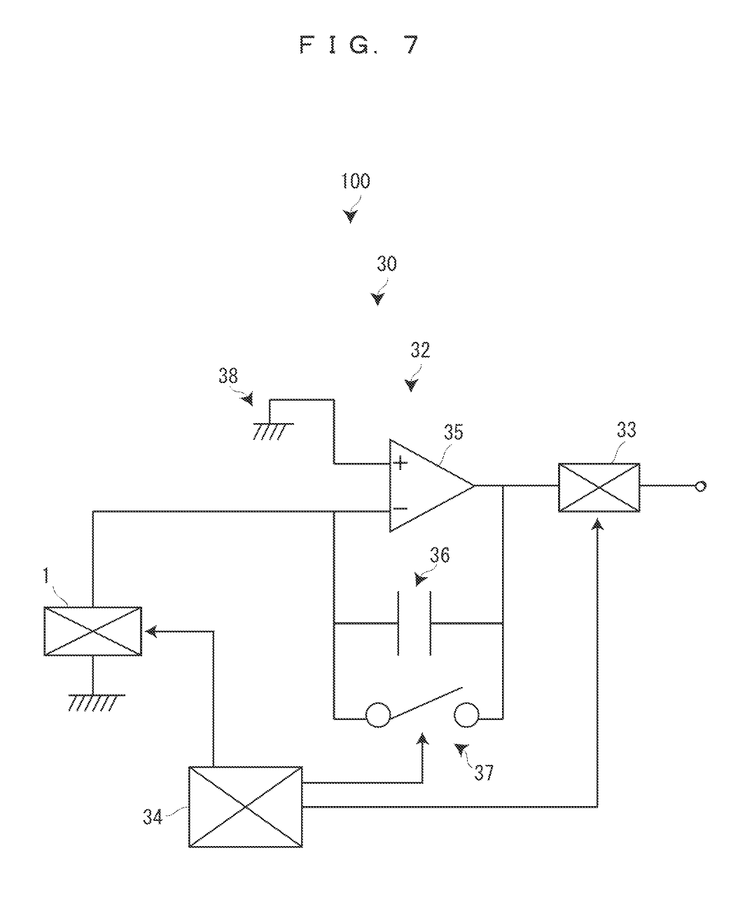

Next, referring to FIG. 7, an infrared ray detection device 100 will be explained. The infrared ray detection device 100 has a structure in which the above mentioned infrared ray detection element 1 is connected to the detection circuit 30 which detects the change of electric charges of the sensor section 4 (pyroelectric body layer). In fact, the detection circuit 30 is connected via wirings to an element array having a number of infrared ray detection elements 1 in a matrix shape. The detection circuit 30 has a switched capacitor circuit 32 which detects the electric charges generated from the sensor section 4 as voltage change, a sample hold circuit 33 which samples to output the detected voltage and a timing generation circuit 34 which controls a chopper modulating the infrared rays coming to the infrared ray detection element 1.

The timing generation circuit 34 outputs timing generation signals to the sample hold circuit 33 and the switch 37 based on square wave signals generated for controlling the chopper.

The switched capacitor circuit 32 has an operational amplifier 35, a feedback capacitor 36 and the switch 37 and is connected as illustrated in FIG. 7. The electric charges generated in the infrared ray detection element 1 is such that the voltage thereof is multiplied by Cp/Cf by simple calculation when capacitance of the infrared ray detection element 1 is expressed as Cp and capacitance of the feedback capacitor 36 is expressed as Cf. The switch 37 repeats on/off operation in synchronization with the timing generation signals output by the timing generation circuit 34, the voltage of the electric charges accumulated in the feedback capacitor 36 is detected while the switch 37 is being turned off, and the voltage in the feedback capacitor 36 is cleared in preparation for a next detection when the switch 37 is turned on.

The sample hold circuit 33 detects (samples) a voltage at a certain moment of the intermittently detected voltages and contributes to detection responsivity. The timings of the samplings are in synchronization with the timing generation signals of the timing generation circuit 34.

In the detection circuit 30, with a state that the infrared ray detection element 1 is applied with voltages based on the timing generation signals of the timing generation circuit 34, when the infrared rays modulated by the controlled chopper are irradiated, electric charges from the first pyroelectric body layer 12 and the second pyroelectric body layer 14 of which temperature changes periodically are generated (an amount of electric charges change). Then, the signals of the infrared ray detection element 1 are amplified by the switched capacitor circuit 32 and are detected. Finally, the intermittently detected voltages are sampled and the voltages are output. The output of voltages allows to detect whether the infrared rays are irradiated or not and the quantity thereof.

The output voltages correspond to the electric charges generated from the first pyroelectric body layer 12 and the second pyroelectric body layer 14, and it is possible to know whether the infrared rays are irradiated or not and the quantity thereof based on voltage difference, that is, change of generated electric charges. Further, since the output voltages are proportional to the quantity of the electric charges generated from the first pyroelectric body layer 12 and the second pyroelectric body layer 14, the more the electric charges are generated from the pyroelectric body layers, the more the voltages are output. In other words, the infrared ray detection element 1 of the invention which generates more electric charges with respect to the quantity of the incident infrared rays (the area of the infrared ray light reception surface) described above outputs more voltages, which means that a considerable voltage difference can be output with respect to a small difference of the incident quantity of the infrared rays and incidence of small quantity of the infrared rays. Therefore, it is possible to provide the infrared ray detection device 100 having high sensitivity.

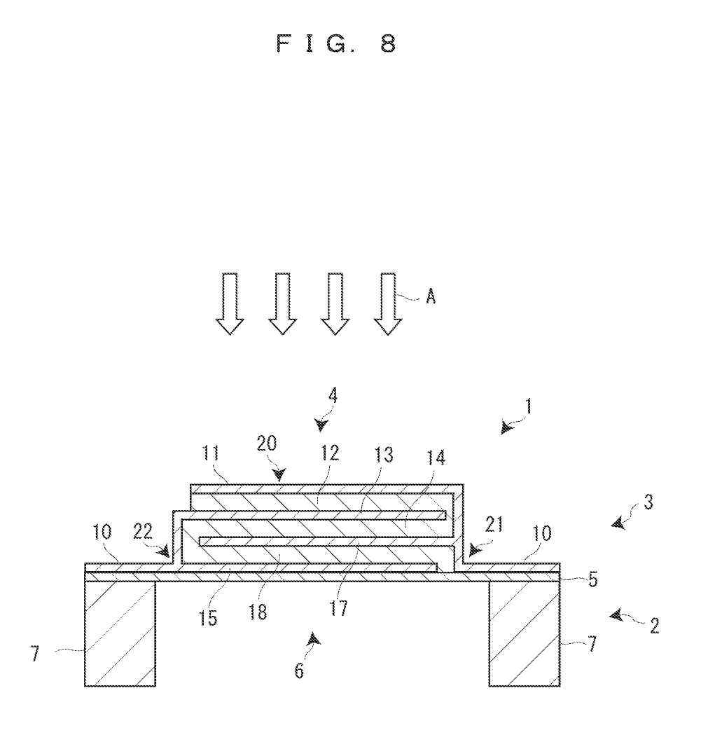

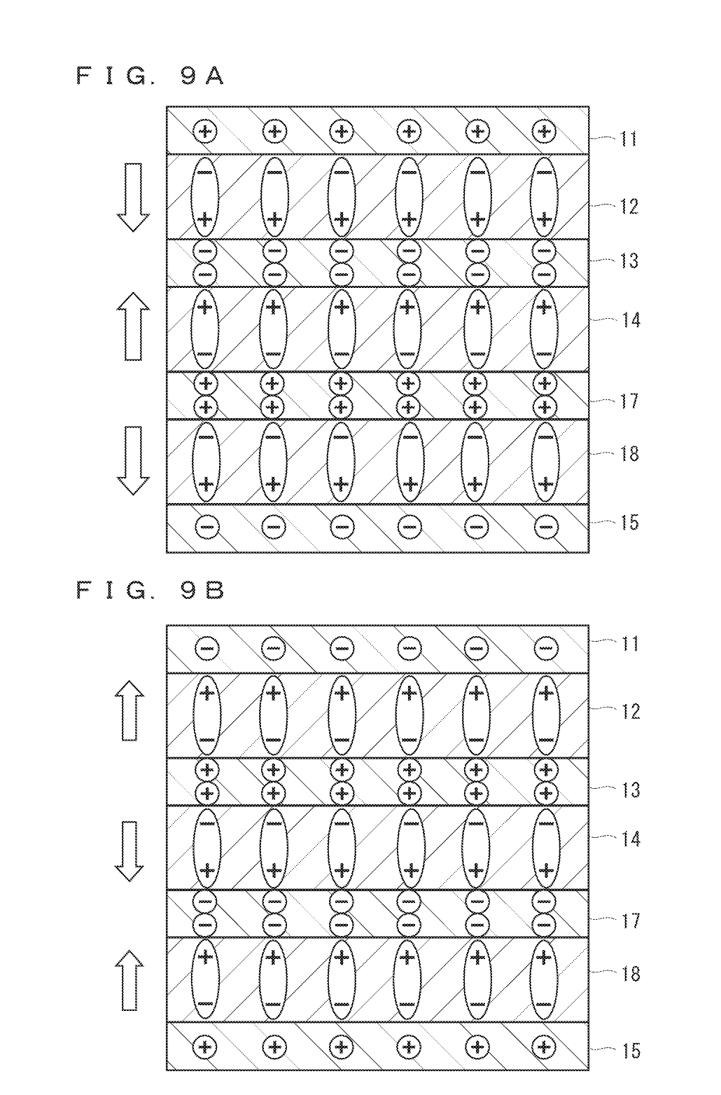

Hereinafter, referring to FIGS. 8 to 9B, a modification of the infrared ray detection element 1 according to the embodiment will be explained. The infrared ray detection element 1 of the modification has a structure in which one more pyroelectric body layer and one more intermediate electrode layer are laminated in the sensor section 4 than that of the above mentioned embodiment.

As illustrated in FIG. 8, the sensor section 4 of the modification has the front side electrode layer 11 having the light reception surface 20 on which the infrared rays come, the first pyroelectric layer 12, the first intermediate electrode layer 13, the second pyroelectric body layer 14, a second intermediate electrode layer 17, a third pyroelectric body layer 18 and the back side electrode layer 15 sequentially laminated. One end of the front side electrode layer 11 extends to cover ends of the first pyroelectric body layer 12 and the second pyroelectric body layer 14 and is connected to the second intermediate electrode layer 17 having a same polarity at a first connection section 21. Further, one of the wiring sections 10 is connected to the first connection section 21. While, the first intermediate electrode layer 13 extends to cover ends of the second pyroelectric body layer 14 and the third pyroelectric body layer 18 and is connected to the other wiring section 10 at a second connection section 22 extending on the support plate section 5. Although not illustrated in FIG. 8, as same as the above mentioned basic embodiment, the pair of wiring sections 10 extending on the support plate section 5 are formed in an elongated shape extending to right and left to be symmetrical at 180 degrees seen from above. Further, the front side electrode layer 11/the second intermediate electrode layer 17 and the first intermediate electrode layer 13/the back side electrode layer 15 are arranged so as not to electrically conduct with each other.

As same as the infrared ray detection element 1 of the basic embodiment, the infrared ray detection element 1 of the modification is performed with the polarization process. In the modification, after the infrared ray detection element 1 is fabricated, the first pyroelectric body layer 12, the second pyroelectric body layer 14 and the third pyroelectric body layer 18 are performed with the polarization process by applying voltages to the pair of wiring sections 10. The polarization process controls the polarization directions as illustrated in FIGS. 9A and 9B. In other words, the polarization process is performed such that the polarization direction of each pyroelectric body layer is set to a reverse direction mutually via each intermediate electrode layer. The polarization direction of each pyroelectric body layer may be either direction as illustrated in FIGS. 9A and 9B.

The polarization process may be performed after the infrared ray detection element 1 is fabricated and the polarization directions of the three pyroelectric body layer are controlled by a single polarization process as described above, or the polarization process may be performed in a fabrication process of the infrared ray detection element 1 and the polarization process is performed per pyroelectric body layer to control the polarization direction.

The infrared ray detection element 1 of the modification has the structure in which the three pyroelectric body layers are laminated, with the front side and the back side of each pyroelectric body layer being sandwiched by electrodes, and since the polarization directions are controlled alternately, it is possible to increase electric charges generated from the sensor section 4. In other words, since much more generated electric charges (of three layers) can be obtained on a same infrared ray light reception area, it is possible to detect a difference of the incident amount in detail of the infrared rays and to provide the small-sized infrared ray detection device 100 having high detection sensitivity. More pyroelectric body layers and electrode layers may be laminated to form a structure in which the sensor section 4 has equal or more than four pyroelectric body layers.

According to the infrared ray detection element 1 and the infrared ray detection device 100 as explained in detail hereinbefore, since the plurality of pyroelectric body layers are laminated to sandwich the electrode layers therebetween and the polarization directions of the pyroelectric body layers adjacent in the laminated direction are controlled to different directions to one another, it is possible to form the infrared detection element 1 having many electric charges on the small infrared ray light reception area. Since the infrared rays are detected based on the change of electric charges by the incident infrared rays by the infrared ray detection element 1 having many electric charges, it is possible to detect slight incidence of the infrared rays and the difference of the incidence amount of the infrared rays as change amount of large electric charges and to provide the infrared ray detection device 100 having extremely high sensitivity.

### REFERENCE NUMERALS

1:infrared ray detection element 2:frame section 11:front side electrode layer 12:first pyroelectric body layer 13:intermediate electrode layer 14:second pyroelectric body layer 15:back side electrode layer 30:detection circuit 100:infrared ray detection device.

1. An infrared ray detection element comprising:
a plurality of pyroelectric layers that are laminated in a same direction as an incident direction of infrared rays;
one or more intermediate electrode layers laminated between the plurality of pyroelectric layers;
a front side electrode layer that is laminated on a front side of the pyroelectric layer positioned at a top side; and
a back side electrode layer that is laminated on a back side of the pyroelectric layer positioned at a bottom side,
the two pyroelectric layers adjacent in a front and back direction performed with a polarization process such that polarization directions thereof are set to reverse directions to each other, the plurality of pyroelectric layers connected in parallel having an intermediate electrode layer in common, and using added polarization electric charges of a plurality of pyroelectric layers as generated electric charges for detection.

2. The infrared ray detection element according to claim 1, wherein the pyroelectric layer is made of a ferroelectric.

3. An infrared ray detection device comprising:
an infrared ray detection element as set forth in claim 1; and
a detection circuit that is connected to the front side electrode layer, the one or more intermediate electrode layers and the back side electrode layer, and detects change of electric charges in the plurality of pyroelectric layers.
